(19) United States
(12) Patent Application Publication
(10) Pub. No.: US 2006/0134379 A1
(43) Pub. Date: Jun. 22, 2006

(54) Method for reducing kinetic friction

(76) Inventor: Esko Pulkka, Voikkaa (FI)

Correspondence Address: Kubovcik & Kubovcik;The Farragut Building, Suite 710, 900 17th Street N W, Washington, DC, 20006, US

(21) Appl. No.: 10/552,616

(22) PCT Filed: Apr. 7, 2004
(86) PCT No.: PCT/FI04/00211

§ 371 Date: Oct. 6, 2005

(30) Foreign Application Priority Data
Apr. 10, 2003 (FI) 20030538

(51) Int. Cl. G11B 5/64; B44C 5/04

(52) U.S. Cl. 428/141; 428/148

(57) ABSTRACT

This specification describes a method for reducing kinetic friction by means of profiled surface patterns when devices and appliances of different materials, sizes and shapes are in contact with air, gas and liquid masses. The method can be used above all to achieve savings in energy consumption in means of transport by providing their surfaces with profiled surface patterns. The method is also suited for use in numerous other applications where kinetic friction between the aforesaid masses and devices and appliances is to be reduced for a specific reason, but those are not covered by the scope of this application.

The aim of the present invention is to reduce kinetic friction in cases where devices and appliances of different materials, sizes and shapes as described later on are in contact with air, gas or liquid masses, where either the said masses are moving in relation to the said devices and appliances or the said devices and appliances are moving in the said masses, on the surface of a mass, e.g. in a liquid.

Kinetic frictional resistance can be reduced by providing the surfaces of devices and appliances with profiled surface patterns adapted to the size and shape of the devices and appliances in question. The profiled surface patterns may consist of either engraved or raised surface patterns. The size and shape of the pits and bulges are determined according to the size and shape of the devices and appliances. In symmetrical devices and appliances, such as e.g. gently arched surfaces, they may have an identical regular shape, such as a spherical calotte, which may be either a pit or a bulge. More sharply bent surfaces require smaller pits or bulges than in the above-mentioned case.

The pit or bulge may also have a shape other than spherical calotte, different rounded shapes of a truncated cone, and resembling the shape of the edge of an oval or closed shell. It would be possible to make an almost unlimited number of different shapes of these pits or bulges, but would it be sensible except as a way of sidestepping the idea, space the simplest shape is surely the best solution. The aim is not to obtain a patent on pits and bulges of different sizes and shapes, but on ways in which these can be used methodically to reduce kinetic friction in these devices and appliances described here, which at present are known as completely smooth-simplified objects.

The reduction of kinetic friction in this manner is based on a physical phenomenon that has been known at least since the 19^{th} century. A good example is the golf ball, which was patented already about a hundred years ago. A golf ball with a profiled surface flies to a distance of about 230 m, whereas a smooth surfaced golf ball flies only about 90 m, so the difference factor is about 2½. Holding the ball in the hand, it seems that the profiled surface is of little consequence, but its effect is of a magnificent order. The reduction of air resistance by a factor of about 2.5 is such a great achievement that it is advisable to apply this phenomenon on a large scale to other devices and appliances as well. It is true that this phenomenon has been applied in a few other devices and appliances besides balls, including the golf ball. These are U.S. Pat. No. 4,973,048 (A 63 B 65/00)=Nemeth's javelin. U.S. Pat. No. 284 302 (B 64 C 1/38)=Transversely fluted automobile. U.S. Pat. No. 5,289,997 (B 64 C 1/38)=Flat rear surfaces, truck, motor boat and gun bullet. U.S. Pat. No. 1,864,803=Splined propeller. As far as we know, none of these devices and appliances have been taken into industrial production, at least not in any significant degree. Otherwise they would be in everyday use around the world.

It is known that a roughness of the surface of a device or appliance produces a physical effect when the surface meets a flow. The roughness of the surface disrupts the flow and reduces friction. The shape and size of the roughness have different effects on the reduction of kinetic friction. If the rough profiled pattern is too unsubstantial, its, effect is likewise unsubstantial. If the rough profiled pattern is too large, then the effect is to the contrary, in other words, it increases the kinetic friction. An optimum size and has been found in the golf ball, but this size and shape can not be exclusively used in all these devices and appliances to be presented here because they differ from the golf ball in respect of shape and size. The golf ball is only an example of how this physical phenomenon should be applied to other devices and appliances as well.

Shuttle and wedge shaped devices and appliances tailor made to reduce kinetic friction. In these, too, surfaces with profiled patterns reduce friction as compared to a smooth surface because in any case the largest cross-section of the device or appliance forms a plane that offers the greatest resistance to motion.

As the devices and appliances differ from each other already because of their size and shape, it is hardly possible to enhance the performance by a factor of about 2.5 in all the cases in which this method is applied. At low speeds, the advantage will be small, if at all measurable, regardless of the nature of the device or appliance. At higher speeds, an advantage is always achieved. Even a slight improvement in the performance is worth while because the amount of materials to be modified remains almost unchanged. The only additional costs arise from the tools, but in large series their cost will be almost nil.

The devices and appliance may move or be stationary against the flow at an oblique angle, in which case there arises a slip angle. Therefore, the side surfaces have to be profiled as well to reduce the slip component.

The profiled patterns also stiffen the structure of the devices and appliances. Whether this is an advantage or a drawback depends on the intended use. An advantage may be achieved due to the reduction in material thickness especially in plate structures. In the case of elastic materials, it may even constitute a drawback as it hinders adaptation.

Nature provides a model example of profiling. There is at least one sea animal that has a head with a bump profile, viz. the humpback whale. The humpback whale makes a round trip from one polar region to the other every year, the distance even in one direction being thousands of kilometers. The tubercles on the head of the whale are surely not useless, but they help serve energy during the long swim. The head with tubercles on it breaks the bonds of water and makes swimming easier. No doubt nature would not have prepared hindrances to such a great effort.

Another example found in nature is the crocodile. It has an armor-like skin protecting it against injury, but the skin also has many bumps on it, and surely not without purpose. As we know, the animal is very gawky and normally would not be able to catch any prey, but in the course of millions of years it has developed an effective method of preying. It lies in ambush near the water's edge at the shore, waiting for prey animals coming to drink, with only its eyes and nostrils above the water surface. When a suitable chance appears, it attacks the prey animal and often manages to kill the prey. In this case, too, the bumpy skin breaks the bonds of water, permitting a faster attack while at the same time contributing towards preserving the species.

It is unimportant how the driving force acting on the devices and appliances is generated, either by an impact or by applying a continuous driving force to them.

The details of the features of the solution of the invention are presented in the claims below.

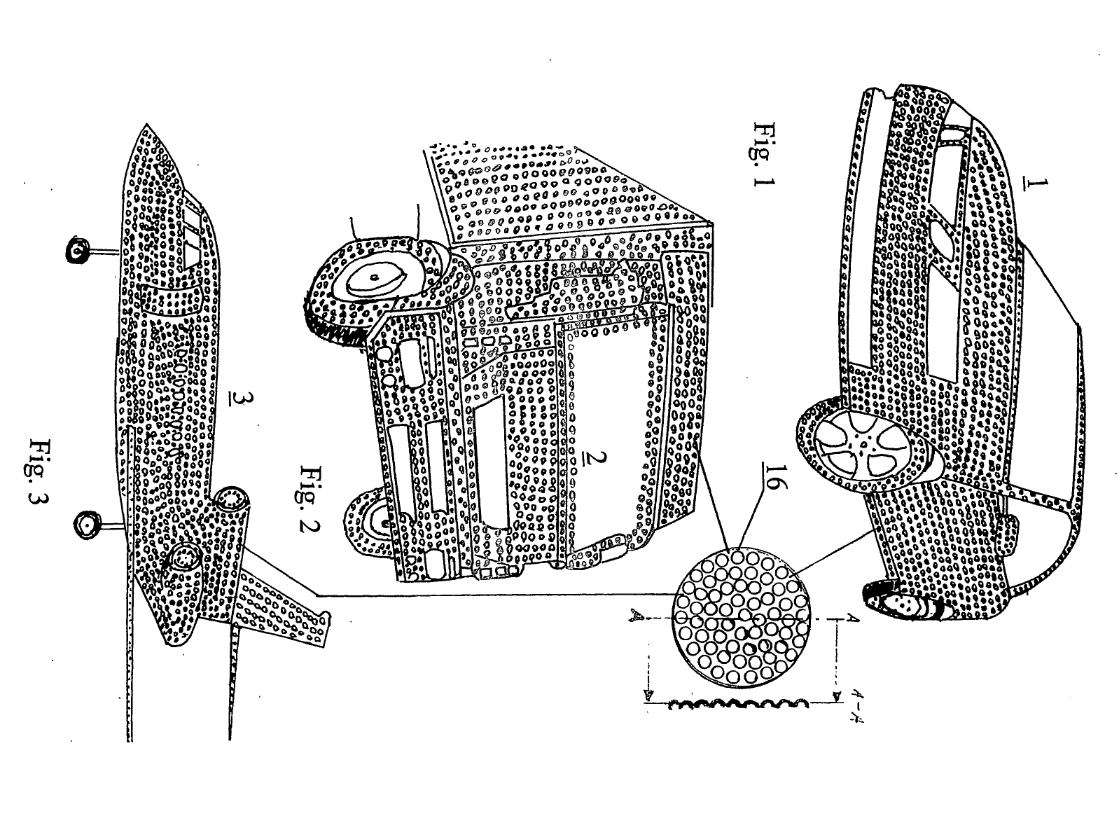

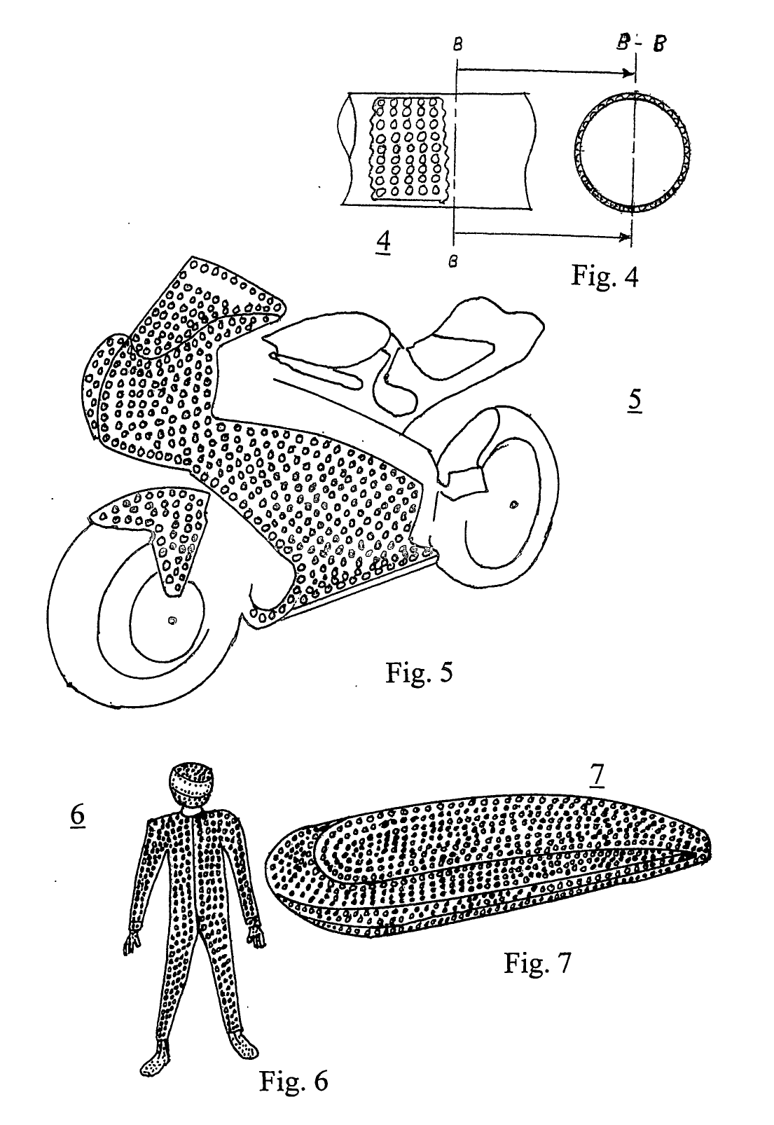

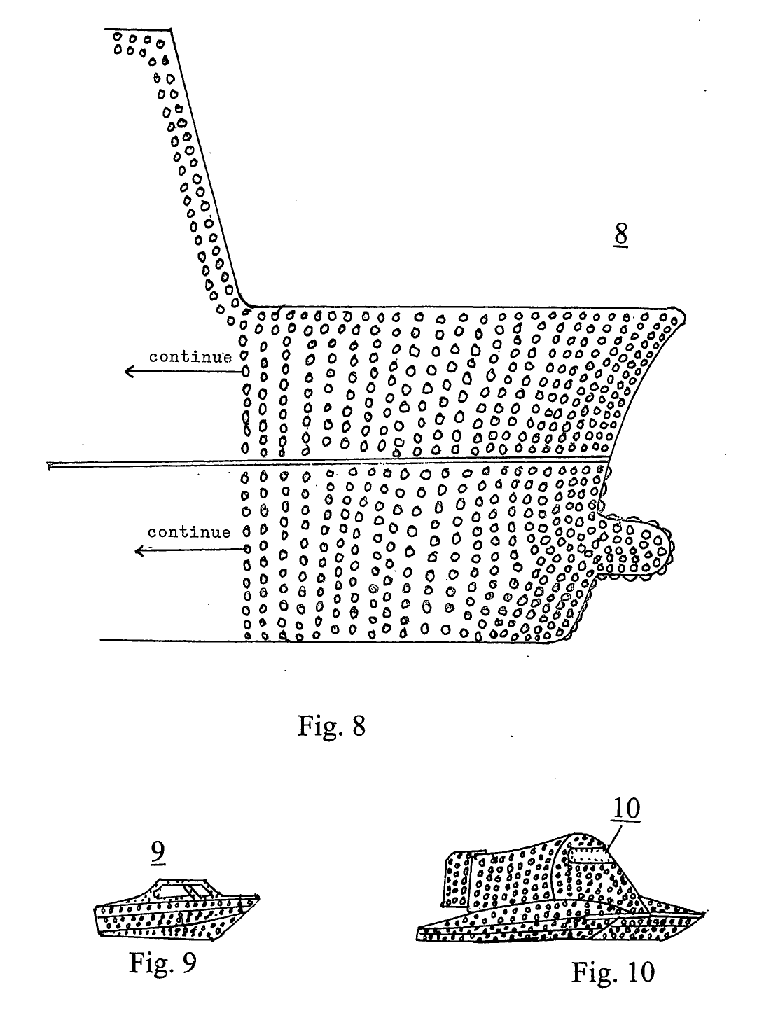

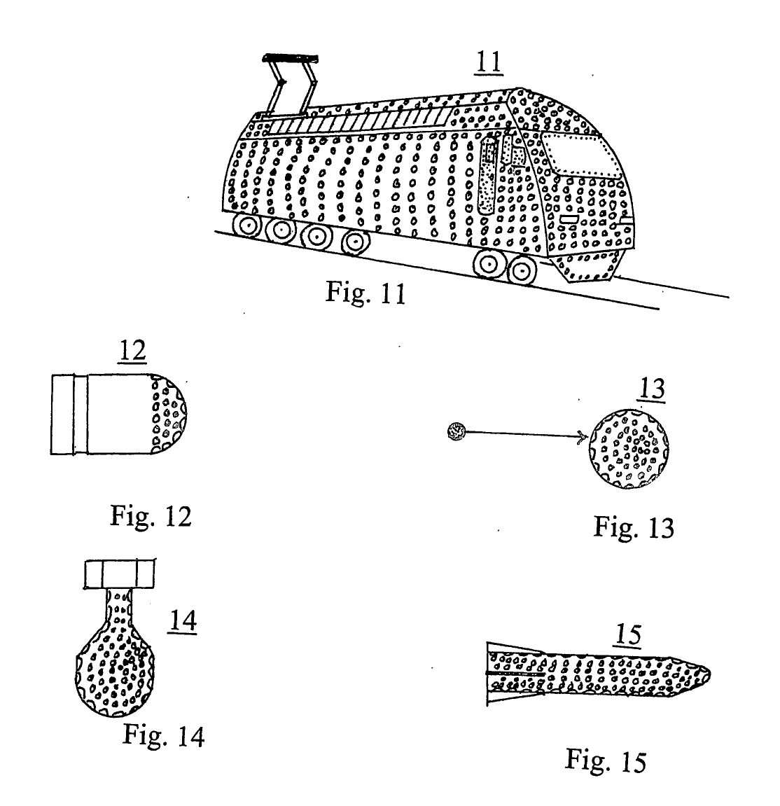

In the following, the invention will be described in detail with reference to the attached drawings, wherein FIGS. 1-15 present preferred embodiments of the solution of the invention, showing a number of devices and appliances so far known as smooth-surfaced ones but which can be provided with pattern profiled surfaces to save energy and increase the speed and range:
Automobiles 1, 2, all types covered by this designation. Examples are given here only in FIG. 1 and 2, because in all other versions the same principle is applied.
Trains 11, all types covered by this designation, a locomotive being shown as an example in FIG. 11.
Trailed vehicles, such as trailers.
Vehicle top boxes 7. FIG. 7.
Motor cycles 5, FIG. 5. Motor sledges and buggies.
Airplanes 3, FIG. 3. Airships, helicopters, sailplanes and other flying devices, such as flying models and comparable devices.
Rockets and missiles. FIG. 15.
Projectiles 14, grenades and aerial bombs. FIG. 14.
Bullets and shots 12, 13. FIGS. 12 and 13.
Ships 8, all types covered by this designation. As an example, FIG. 8 shows a drawing of the bow of a vessel. The bulge of ships can be implemented as a vibrating structure, which will be better able to break the bonds of water than a solid structure. As an alternative, a more elongated structure could be used instead of a point-form structure like this. Such a structure would have a more extensive effect on breaking the bonds of water, extending deeper to the bottom part of the prow. Such a device could be separate structure attachable to the bow part of the ship and not necessarily a fixed structure. An interchangeable part. In long vessels, the effect of the profiling of the rear part after the largest sectional plane decreases, but still it does not have an adverse effect, either. A computer model produces such a result. No practical experiments with a prototype have been carried out. In vessels with commander's cabins and engine spaces in the rear part, the profiling may extend over the entire vessel.
Motor boats 8, 10, FIGS. 9 and 10. Water-jet-powered boats, water scoters, canoes, boats, hovercraft.
Submarines and torpedoes.

In the case of devices and appliances for which a good, undisturbed and perfect field of vision is important for reasons of controllability or other factors, the profiling of transparent surfaces should be omitted where profiling would obscure or distort the field of vision.

The surface pattern profiling also works in closed spaces, such as piping. It is unimportant which is moving, the aforesaid masses or the devices and appliances, with respect to each other. The final result is the same. The inner surfaces of pipes are provided with profiled surface patterns in the same way as the outer surfaces of the devices and appliances listed above. The applications include various piping installations, such as oil and gas pipes, air conditioning, water and sewage pipes. The first-mentioned of these may be hundreds of kilometers long, so pumping energy would be saved due to lower pipe losses. Moreover, intermediate pumping stations could be located at longer distances between them. The feed channels of the turbines of hydroelectric power stations as well as the feed pipes with a large head of fall used to supply pipe-fed turbines can be provided with profiled surface patterns, which will increase the power output because the flow resistance decreases. The intake and exhaust manifolds as well as exhaust pipes of combustion engines can be provided with internal profiled surface patterns, which would improve the breathing capacity of the engines and increase their power output.

Fixed structures subject to stress from strong winds, water currents and waves should be provided with profiled surface patterns to reduce the stress if necessary to improve durability or performance. Several examples can be found, such as the towers of wind power plants, the pylons and conductors of power transmission lines, underwater and other structures of bridge piers if their performance is to be improved, and tall and round TV towers.

Sportsgear and sportswear can be provided with profiled surface patterns, but this probably requires some changes in the rules. In throwing sports, the javelins, shots, hammers, discs etc., if it is desired that they fly farther than the earlier smooth-surfaced models. The following sportswear could be provided with profiled surface patterns, which would reduce the kinetic friction of air flow more or less, depending on the case and the speed used, as compared to smooth-surfaced sportswear:
Full-length competition wear 6, FIG. 6. Ski jumping, fast downhill skiing, slalom, skating and skiing.
Helmets, FIG. 6. Gauntlets, the shoe part of skates, jumping shoes, spikes, gym shoes and masks.
Goggles and visors only as far as the surface patterns do not obstruct visibility.
Partially close-fitting sportswear, such as in rowing the person sits with his/her back facing the direction of advance, the back thus dividing the air flow, so the person has to wear a jumper on his/her upper body (the shanks of the oars also have to be profiled).
In other sports the trouser part as well.
Attachable number tags, advertisements and vests also have to be profiled.

In motor sports, all types of racing cars should be provided with profiled surface patterns covering the vehicle almost completely, maybe the ailerons only partially. Likewise, the inner surfaces of the intake and exhaust manifolds and exhaust pipes and air inlet ports of the engines, and even the sides of the tires, because when the vehicle is running along a gentle curve the side of the car is moving obliquely in the direction of advance, and so are the tires. Projecting parts such as mirrors and handrails etc. should be profiled as well.

In motor cycle sports, about the same measures as in the case of cars, with the addition of the plexiglass and driver's overalls, FIGS. 5 and 6. To be profiled as well. In motor boat sports, FIG. 10, about the same measures apply as above, but additionally the bottom part should be profiled. In the case of waterjet-powered boats, additionally the water inlet and exhaust channels should be profiled.

The cigar-shaped bodies of ice chute toboggans and competition wear to be profiled as well.

The profiled surface patterns can be made in many ways, but always adapted in relation to the shape and size of the devices and appliances. Plate-like pieces needed in the devices and appliances can be provided with profiled surface patterns already during the rolling and pressing stage. In the case of thick bodies, in connection with casting and other working. In the case of garments, in connection with weaving and other production processes. It is also possible to attach a previously profiled separate surface to a ready-made device or appliance by welding, gluing, riveting, screwing, vulcanizing or by similar traditional methods. If necessary, the traditional shapes of devices and appliances can be reshaped to gain the best benefit. Perhaps the trend is now increasingly towards round and curved shapes. Devices and appliances already in use can be renewed by only reshaping the surface parts. In this presentation, the number of figures in the drawings has been limited to 15 because their number would be too large if all the different versions were to be illustrated.

Anyway, the drawings reveal the principle of how the method should be applied in the case of different devices and appliances.

The shapes and sizes of the profiled patterns 16 can not be accurately defined because the devices and appliances are different in relation to each other. In principle, there might be an almost unlimited number of sizes and shapes of patterns, and therefore only the method or means is patented, i.e. the way in which profiling can be used in the devices and appliances mentioned here to reduce kinetic friction as compared with smooth-surfaced devices and appliances.

1. A method for reducing kinetic friction, characterized in that devices and appliances (1-15) of different materials, sizes and shapes are provided with profiled surface patterns to reduce kinetic friction when the said devices and appliances are in contact with air, gas or liquid masses.

2. A method according to claim 1, characterized in that the surfaces of the devices and appliances of different materials, sizes and shapes are profiled with differently sized sunken or raised patterns or with combinations of such patterns, or even helical patterns, wherein the surfaces profiled with sunken and raised patterns may be the shape of a spherical calotte or truncated cone or imitations of these shapes and/or imitations of polygonal, roundish or oval shapes, or resembling the shape of the edge of a closed shell and the bumped bulges in the midpart of a crocodile's back.

3. A method according to claim 1, characterized in that the devices and appliances of different materials, sizes and shapes are provided with profiled surface patterns adapted in relation to their intrinsic size and shape so that the size and shape of the pattern may vary in a way best suited to the devices and appliances in each case. They may even be partial.

4. Means for reducing kinetic friction, characterized in that devices and appliances (1-15) of different materials, sizes and shapes are provided with profiled surface patterns to reduce kinetic friction when the said devices and appliances are in contact with air, gas or liquid masses, comprising for example the following devices and appliances, which at present are known as being completely smooth-surfaced:
Automobiles (1, 2), and all others covered by this designation.
Trains (11), and all devices covered by this designation.
Trailed vehicles, such as trailers and vehicle top boxes (7).
Motor cycles (5). Motor sledges and buggies.
Airplanes (3). Helicopters, airships and other flying devices, such as sail-planes and flying models.
Rockets and missiles (15).
Projectiles, grenades and aerial bombs (14).
Bullets and shots (12 and 13).
Ships (8), and all devices covered by this designation, preferably also the above-water and underwater parts, such as implementing the bulge as a vibrating and larger structure.
Motor boats (9 and 10). Water-jet-powered boats, water scoters, canoes, boats, sailboats and hovercraft. Above-water and underwater parts as well.
Submarines and torpedoes.
Surfing boards.

5. Means according to claim 4, comprising the following devices and appliances of a closed nature, such as various piping installations, which are at present known as having completely smooth inner surfaces:
Oil and gas pipes (4).
Air conditioning, water and sewage pipes.
Feed channels and throats of turbines in hydropower plants.
Feed pipes with a large head of fall used to supply pipe-fed turbines.
Intake and exhaust channels and manifolds, exhaust pipes (4) and air inlet ports and channels of combustion engines.

6. Means according to claim 4, characterized in that they comprise the following fixed structures, which at present are known as completely smooth-surfaced structures, such as:
Rotor towers of wind power plants, tall and round TV masts/towers.
Pylons and conductors used in the transmission of electric power.
Those parts of bridge piers that are in contact with water.
All other structures that can be profiled if the structure permits and if necessary for protection or performance, to reduce the effect of strong winds or water currents or waves. E.g. gas or oil drilling platforms/production platforms.

7. Means according to claim 4, characterized in that they comprise those parts of devices and appliances that are supposed to be transparent, which at present are known as being always completely smooth-surfaced, such as:
Windshields and rear windows of vehicles.
Protective goggles and visors as personal equipment.
Windows and protective hoods in different means of transport.
Protective hoods of vehicle lamps as far as no obstruction to illumination arises.
The profiling has to be carried out in such manner that it does not obstruct the field of vision.

8. Means according to claim 4, characterized in that they comprise the following sports gear and garments, which at present are known as being completely smooth-surfaced, such as:
Full-length competition wear (6). Ski jumping, fast downhill skiing, slalom, skating and skiing.
Helmets, gauntlets, (6), the shoe part of skates, jumping shoes, spikes, gym shoes and masks.
Rowing jumpers. (The shanks of oars to be profiled as well.)
Trousers and jumper combinations.
Attachable number tags, advertisements and vests.

9. Means according to claim 4, characterized in that they comprise devices and appliances used in motor sports, which at present are known as being completely smooth-surfaced, such as:
Body parts of automobiles (1 and 2), ailerons, mirrors, intake and exhaust manifolds of engines, exhaust pipes, air intake ports, projecting handrails and sides of tires.
Surface parts of motor cycles, plexiglass shields, driver's overalls, helmet, intake and exhaust manifolds of the engine, exhaust pipes, brace rods and visor. FIGS. 5 and 6, as well as motor sledges and buggies, profiling of surface parts as far as possible. At present they are known as being completely smooth-surfaced. For the engines, the same measures as for those above, and also surface profiling of ice chute toboggans and competition wear. At present, these are known as being completely smooth-surfaced.

10. Means according to claim 4, characterized in that they comprise the profiling of athletics gear, such as javelins, discs, hammers and shots. At present, these are known as being completely smooth-surfaced.

11. Means according to claim 4, characterized in that they also comprise a warning about profiling of transparent surfaces if the profiling is so implemented that the pattern could produce a burning lens effect when exposed to sun beams. This can be prevented by changing the profiling patterns or by moving the heat sensitive surface farther away.
